(19) United States
(12) Patent Application Publication
(10) Pub. No.: US 2026/0040389 A1
(43) Pub. Date: Feb. 5, 2026

(54) METHOD AND APPARATUS FOR PROVIDING TERMINAL MOBILITY BETWEEN NON-TERRESTRIAL NETWORK AND TERRESTRIAL NETWORK

(71) Applicant: ELECTRONICS AND TELECOMMUNICATIONS RESEARCH INSTITUTE, Daejeon (KR)

(72) Inventors: You Sun HWANG, Daejeon (KR); Jaesheung SHIN, Daejeon (KR); Jae Wook SHIN, Daejeon (KR); Sung-Min OH, Daejeon (KR)

(73) Assignee: ELECTRONICS AND TELECOMMUNICATIONS RESEARCH INSTITUTE, Daejeon (KR)

(21) Appl. No.: 19/270,090

(22) Filed: Jul. 15, 2025

(30) Foreign Application Priority Data
Aug. 1, 2024 (KR) 10-2024-0102301
Jul. 4, 2025 (KR) 10-2025-0089835

(51) Int. Cl. H04W 76/27; H04W 36/08

(52) U.S. Cl. CPC H04W 76/27; H04W 36/083

(57) ABSTRACT

A method of a terminal may comprise: establishing RRC connected states with a first base station and a second base station; transmitting, to a mobility management function entity and via the first base station, a PDU session establishment request message including dual steering capability information indicating support of a dual steering function of the terminal; performing a first RAN-specific resource setup procedure according to a first PDU session request of the mobility management function entity; establishing a first session with the first base station according to the first RAN-specific resource setup procedure; performing a second RAN-specific resource setup procedure according to a second PDU session request of the mobility management function entity; and establishing a second session with the second base station according to the second RAN-specific resource setup procedure.

### CROSS-REFERENCE TO RELATED APPLICATIONS

This application claims priority to Korean Patent Applications No. 10-2024-0102301, filed on Aug. 1, 2024, and No. 10-2025-0089835, filed on Jul. 4, 2025, with the Korean Intellectual Property Office (KIPO), the entire contents of which are hereby incorporated by reference.

### BACKGROUND

### 1. Technical Field

The present disclosure relates to a technique for providing terminal mobility between a non-terrestrial network and a terrestrial network, and more particularly, to a technique for providing terminal mobility between a non-terrestrial network and a terrestrial network, which enables a terminal to receive services continuously from a terrestrial base station and a satellite base station.

### 2. Related Art

In order to process the rapidly increasing wireless data traffic, communication networks that use frequency bands higher than those used in Long Term Evolution (LTE) or LTE-A (e.g. frequency bands below 6 GHz) are being considered. Such networks include New Radio (NR) communication networks, which can support not only frequency bands below 6 GHz but also those above 6 GHz. Compared to LTE communication networks, an NR communication network can support a wider variety of communication services and scenarios. For example, usage scenarios of NR communication networks may include enhanced Mobile Broadband (eMBB), Ultra-Reliable Low-Latency Communication (URLLC), and massive Machine-Type Communication (mMTC).

NR communication networks can provide communication services to terrestrial terminals. Recently, the demand for communication services has been increasing not only for terrestrial terminals but also for non-terrestrial terminals, such as terminals on airplanes, drones, and satellites. In response, technologies for non-terrestrial networks (NTNs) are being discussed. A non-terrestrial network may be implemented based on NR technology. For example, communication between a satellite and a communication node located on the ground, or a communication node located in a non-terrestrial environment (such as an airplane or drone), may be performed based on NR technology. In a non-terrestrial network, a satellite may perform the functions of a base station in the NR communication network.

Post-5G mobile communication networks are expected to evolve toward an integrated or cooperative structure combining terrestrial and non-terrestrial networks. 3GPP release 19 (Rel-19) is discussing a structure in which a terminal can simultaneously access both a satellite base station and a terrestrial base station. The terminal can be connected to both the terrestrial base station and the satellite base station and receive services from both simultaneously. However, in some cases, the terminal may have difficulty establishing a wireless connection to either the terrestrial base station or the satellite base station. In such cases, the terminal may require a configuration procedure in order to continuously receive services from either the terrestrial or the satellite base station.

### SUMMARY

The present disclosure for resolving the above-described problems is directed to providing a method and an apparatus for providing terminal mobility between a non-terrestrial network and a terrestrial network, which enable a terminal to receive services continuously from a terrestrial base station and a satellite base station.

A method for providing terminal mobility between a non-terrestrial network and a terrestrial network, performed by a terminal, according to a first exemplary embodiment of the present disclosure, may comprise: establishing radio resource control (RRC) connected states with a first base station and a second base station; transmitting, to a mobility management function entity and via the first base station, a protocol data unit (PDU) session establishment request message including dual steering capability information indicating support of a dual steering function of the terminal; performing a first radio access network (RAN)-specific resource setup procedure according to a first PDU session request of the mobility management function entity; establishing a first session with the first base station according to the first RAN-specific resource setup procedure; performing a second RAN-specific resource setup procedure according to a second PDU session request of the mobility management function entity; and establishing a second session with the second base station according to the second RAN-specific resource setup procedure.

The establishing of the RRC connected states may comprise: transmitting, to the mobility management function entity and via the first base station, a registration request message including the dual steering capability information while in a first RRC idle state with the first base station; transmitting, to the mobility management function entity and via the second base station, the registration request message while in a second RRC idle state with the first base station; performing an identification procedure, an authentication procedure, and a non-access stratum (NAS) security procedure with the mobility management function entity; receiving a first registration accept message from the first base station and transitioning to the RRC connected state; and receiving a second registration accept message from the second base station and transitioning to the RRC connected state.

The method may further comprise: in response to an event condition for traffic switching being satisfied, transmitting radio status information of the first base station to the first base station; receiving, from the second base station, a first RRC reconfiguration message for additional establishment of a first data radio bearer; additionally establishing the first data radio bearer with the second base station; and transitioning to an RRC inactive state with the first base station.

The method may further comprise: transmitting an RRC resume request message to the first base station; receiving an RRC resume response message from the first base station; receiving, from the second base station, a second RRC reconfiguration message for deleting the first data radio bearer; deleting the first data radio bearer with the second base station; and establishing a connection with the first base station and transitioning to the RRC connected state.

The establishing of the connection with the first base station and the transitioning to the RRC active state may comprise: receiving, from the first base station, a third RRC reconfiguration message for additional establishment of a second data radio bearer; additionally establishing the second data radio bearer with the first base station; and establishing a connection with the first base station and transitioning to the RRC connected state.

The method may further comprise: transmitting an RRC resume request message to the first base station; receiving an RRC resume response message from the first base station; receiving, from the first base station, a fourth RRC reconfiguration message for additional establishment of a third data radio bearer; additionally establishing the third data radio bearer with the first base station; and establishing a connection with the first base station and transitioning to the RRC connected state.

A method for providing terminal mobility between a non-terrestrial network and a terrestrial network, performed by a first base station, according to a second exemplary embodiment of the present disclosure, may comprise: establishing a radio resource control (RRC) connected state with a terminal; receiving, from the terminal, a protocol data unit (PDU) session establishment request message including dual steering capability information indicating support of a dual steering function of the terminal; transmitting the PDU session establishment request message including the dual steering capability information to a mobility management function entity; receiving a PDU session request message from the mobility management function entity; performing a radio access network (RAN)-specific resource setup procedure with the terminal according to the PDU session request message; and establishing a session with the terminal according to the RAN-specific resource setup procedure.

The establishing of the RRC connected state with the terminal may comprise: receiving, from the terminal, a registration request message including the dual steering capability information in an RRC idle state with the terminal; transmitting the registration request message to the mobility management function entity; relaying an identification procedure, an authentication procedure, and a non-access stratum (NAS) security procedure between the mobility management function entity and the terminal; receiving an initial context setup request message from the mobility management function entity; transmitting a registration accept message to the terminal; and establishing the RRC connected state.

The method may further comprise: receiving, from the terminal, radio status information of the terminal and the first base station; transmitting a first path switch request message to the mobility management function entity; receiving a first path switch complete message from the mobility management function entity; and releasing a connection with the terminal.

The method may further comprise: receiving an RRC resumption request message from the terminal; transmitting a second path switch request message for RRC resumption to the mobility management function entity; receiving a second path switch complete message from the mobility management function entity; and resuming a connection with the terminal.

The resuming of the connection with the terminal may comprise: transmitting, to the terminal, a first RRC reconfiguration message for additional establishment of a first data radio bearer; additionally establishing the first data radio bearer with the terminal; and receiving a first RRC reconfiguration complete message from the terminal and resuming the connection.

The method may further comprise: receiving a first PDU session modification request message from the mobility management function entity; transmitting, to the terminal, a second RRC reconfiguration message for deleting a second data radio bearer; deleting the second data radio bearer with the terminal; receiving a second RRC reconfiguration complete message from the terminal; and transmitting a first PDU session modification response message to the mobility management function entity.

The method may further comprise: receiving a second PDU session modification request message from mobility management function entity; transmitting, to the terminal, a third RRC reconfiguration message for additional establishment of a third data radio bearer; additionally establishing the third data radio bearer with the terminal; receiving a third RRC reconfiguration complete message from the terminal; and transmitting a second PDU session modification response message to the mobility management function entity.

An apparatus according to a third exemplary embodiment of the present disclosure, implemented as a terminal, may comprise at least one processor, wherein the at least one processor may cause the terminal to perform: establishing radio resource control (RRC) connected states with a first base station and a second base station; transmitting, to a mobility management function entity and via the first base station, a protocol data unit (PDU) session establishment request message including dual steering capability information indicating support of a dual steering function of the terminal; performing a first radio access network (RAN)-specific resource setup procedure according to a first PDU session request of the mobility management function entity; establishing a first session with the first base station according to the first RAN-specific resource setup procedure; performing a second RAN-specific resource setup procedure according to a second PDU session request of the mobility management function entity; and establishing a second session with the second base station according to the second RAN-specific resource setup procedure.

The at least one processor may further cause the terminal to perform: in response to an event condition for traffic switching being satisfied, transmitting radio status information of the first base station to the first base station; receiving, from the second base station, a first RRC reconfiguration message for additional establishment of a first data radio bearer; additionally establishing the first data radio bearer with the second base station; and transitioning to an RRC inactive state with the first base station.

The at least one processor may further cause the terminal to perform: transmitting an RRC resume request message to the first base station; receiving an RRC resume response message from the first base station; receiving, from the second base station, a second RRC reconfiguration message for deleting the first data radio bearer; deleting the first data radio bearer with the second base station; and establishing a connection with the first base station and transitioning to the RRC connected state.

In the establishing of the connection with the first base station and the transitioning to the RRC active state, the at least one processor may further cause the terminal to perform: receiving, from the first base station, a third RRC reconfiguration message for additional establishment of a second data radio bearer; additionally establishing the second data radio bearer with the first base station; and establishing a connection with the first base station and transitioning to the RRC connected state.

The at least one processor may further cause the terminal to perform: transmitting an RRC resume request message to the first base station; receiving an RRC resume response message from the first base station; receiving, from the first base station, a fourth RRC reconfiguration message for additional establishment of a third data radio bearer; additionally establishing the third data radio bearer with the first base station; and establishing a connection with the first base station and transitioning to the RRC connected state.

According to the present disclosure, a terminal can transmit a registration request message including information on a support capability for dual steering to a core network. Accordingly, the core network can receive the registration request message including the information on the support capability for dual steering from the terminal, and identify the terminal's dual steering support capability. In addition, according to the present disclosure, the core network can establish a Protocol Data Unit (PDU) session between a terrestrial base station and the terminal, and can also establish a PDU session between a satellite base station and the terminal, thereby enabling the terminal to receive services through multiple paths. Furthermore, according to the present disclosure, the terminal can be connected to both the terrestrial base station and the satellite base station to continuously receive services. Moreover, according to the present disclosure, the terminal connected to both terrestrial and satellite base stations can significantly reduce signaling procedures through a traffic steering procedure.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating exemplary embodiments of an integrated network of a terrestrial network and a non-terrestrial network.

FIG. 5 is a conceptual diagram illustrating exemplary embodiments of an integrated network of a terrestrial network and a non-terrestrial network.

FIG. 6 is a conceptual diagram illustrating exemplary embodiments of a traffic steering method in an integrated network of a terrestrial network and a non-terrestrial network.

FIG. 7 is a conceptual diagram illustrating exemplary embodiments of a traffic steering method in an integrated network of a terrestrial network and a non-terrestrial network.

FIG. 8 is a sequence chart illustrating exemplary embodiments of a network registration method of a terminal.

FIG. 9 is a sequence chart illustrating exemplary embodiments of a PDU session establishment method.

FIG. 10 is a sequence chart illustrating exemplary embodiments of a traffic switching method in a terrestrial network and a non-terrestrial network.

FIG. 11 is a sequence chart illustrating exemplary embodiments of a traffic switching method in a terrestrial network and a non-terrestrial network.

FIG. 12 is a sequence chart illustrating exemplary embodiments of a connection resumption method in a terrestrial network and a non-terrestrial network.

FIG. 13 is a sequence chart illustrating exemplary embodiments of a connection resumption method in a terrestrial network and a non-terrestrial network.

FIG. 14 is a sequence chart illustrating exemplary embodiments of a connection resumption method in a terrestrial network and a non-terrestrial network.

FIG. 15 is a sequence chart illustrating exemplary embodiments of a connection resumption method in a terrestrial network and a non-terrestrial network.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

In the present disclosure, a phrase including “when ˜” may be expressed as a phrase including “based on ˜” or “in response to ˜”. In other words, a phrase including “when ˜” may be interpreted as equivalent or similar to a phrase including “based on ˜” or “in response to ˜”.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

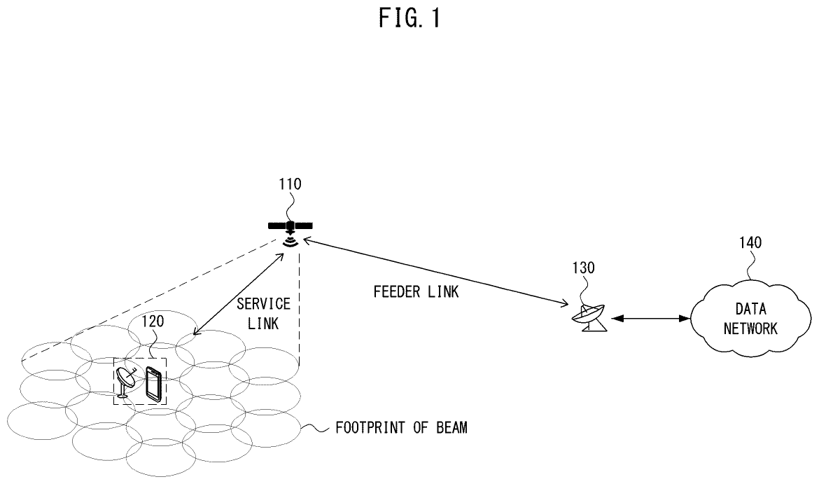

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

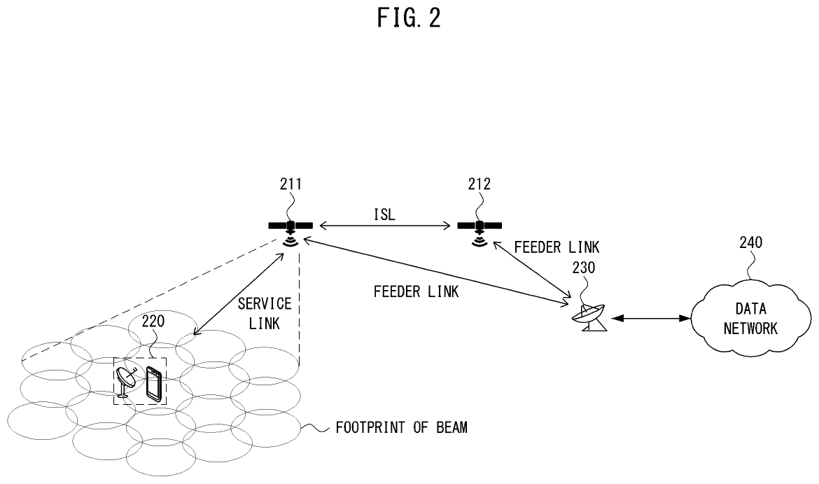

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

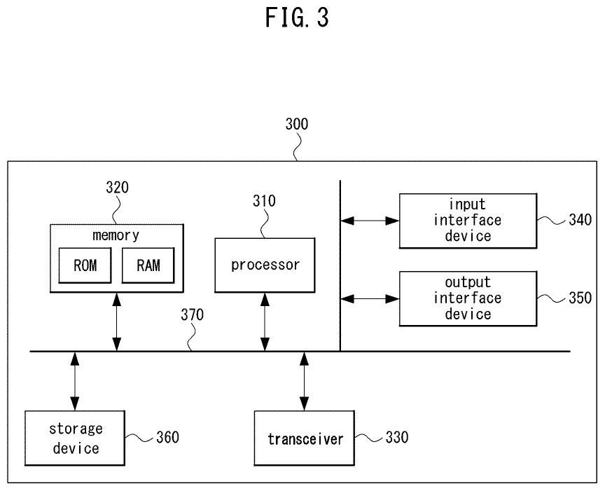

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum (service | <6 GHz (e.g. 2 GHz) | | |
| link) | >6 GHz (e.g. DL 20 GHz, UL 30 GHz) | | |
| Maximum channel | 30 MHz for band <6 GHz | | |
| bandwidth | 1 GHz for band >6 GHz | | |
| capability | | | |
| (service link) | | | |
| Maximum distance | 40,581 | km | 1,932 km (altitude |
| between satellite | | | of 600 km) |
| and communication | | | 3,131 km (altitude |
| node (e.g. UE) at | | | of 1,200 km) |
| the minimum | | | |
| elevation angle | | | |
| Maximum round | Scenario A: 541.46 ms | | Scenario C: (transparent |
| trip delay (RTD) | (service and feeder | | payload: service and |
| (only propagation | links) | | feeder links) |
| delay) | Scenario B: 270.73 ms | | −5.77 ms (altitude |
| | (only service link) | | of 60 0 km) |
| | | | −41.77 ms (altitude |
| | | | of 1,200 km) |
| | | | Scenario D: (regenerative |
| | | | payload: only service |
| | | | link) |
| | | | −12.89 ms (altitude |
| | | | of 600 km) |
| | | | −20.89 ms (altitude |
| | | | of 1,200 km) |
| Maximum delay | 16 | ms | 4.44 ms (altitude |
| variation within | | | of 600 km) |
| a single beam | | | 6.44 ms (altitude |
| | | | of 1,200 km) |
| Maximum | 10.3 | ms | 3.12 ms (altitude |
| differential | | | of 600 km) |
| delay within a | | | 3.18 ms (altitude |
| cell | | | of 1,200 km) |

| | |
|---|---|
| Service link | NR defined in 3GPP |
| Feeder link | Radio interfaces defined in 3GPP |
| | or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in | 541.75 ms | 270.57 ms | 28.41 | ms | 12.88 | ms |
| a radio interface | (worst | | | | | |
| between base | case) | | | | | |
| station and UE | | | | | | |
| Minimum RTD in | 477.14 ms | 238.57 ms | 8 | ms | 4 | ms |
| a radio interface | | | | | | |
| between base | | | | | | |
| station and UE | | | | | | |

Hereinafter, methods for providing terminal mobility between a non-terrestrial network and a terrestrial network in a communication system are described. Even when a method (e.g. transmission or reception of a signal) performed at a first communication node among communication nodes is described, a second communication node corresponding thereto may perform a method corresponding to the method performed at the first communication node (e.g. reception or transmission of the signal). That is, when an operation of a terminal is described, a base station corresponding thereto may perform an operation corresponding to the operation of the terminal. Conversely, when an operation of a base station is described, a terminal corresponding thereto may perform an operation corresponding to the operation of the base station.

Meanwhile, post-5G mobile communication networks are expected to evolve toward an integrated or cooperative structure combining terrestrial networks and satellite networks (i.e. non-terrestrial networks (NTN)). The 3GPP release 19 (Rel-19) is discussing a structure in which a terminal can simultaneously access a satellite base station and a terrestrial base station. The terminal can be connected to both the terrestrial base station and the satellite base station. The terminal can receive services simultaneously from the terrestrial base station and the satellite base station. On the other hand, the terminal may have difficulty in establishing a wireless connection to the terrestrial base station or the satellite base station. The terminal may require a configuration procedure to continuously receive services from either the terrestrial base station or the satellite base station. In the present disclosure, a terrestrial base station may be referred to as a first base station, and a satellite base station may be referred to as a second base station. Conversely, in the present disclosure, a satellite base station may be referred to as a first base station, and a terrestrial base station may be referred to as a second base station.

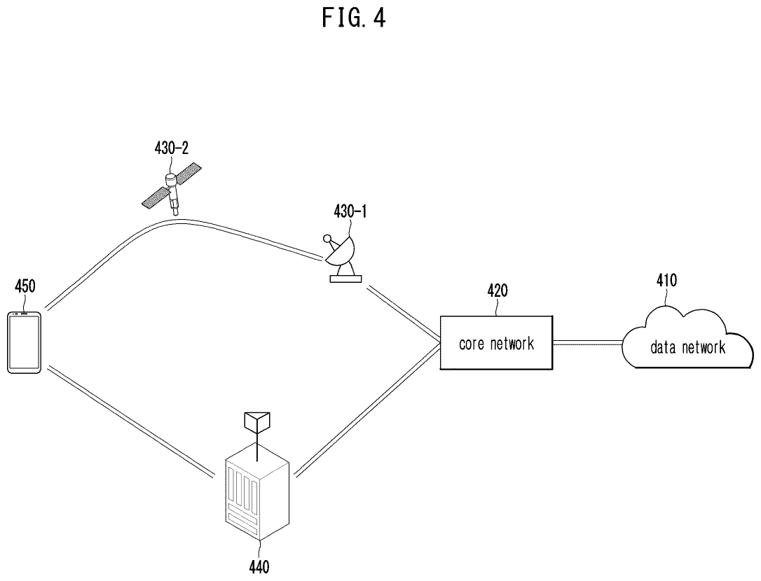

FIG. 4 is a conceptual diagram illustrating exemplary embodiments of an integrated network of a terrestrial network and a non-terrestrial network.

Referring to FIG. 4, a core network 420 may manage a terrestrial network and a non-terrestrial network in an integrated manner. The core network may be connected to a data network 410. The core network may include a network synchronization function or device. The core network may be a 5G core network or a 6G core network. The core network may be connected to a ground station 430-1 of the non-terrestrial network via a backhaul. The ground station of the non-terrestrial network may be an NTN gNB-central unit (CU) of the non-terrestrial network.

The ground station of the non-terrestrial network may be connected to a satellite 430-2 of the non-terrestrial network via a midhaul or a fronthaul. The satellite of the non-terrestrial network may be connected to another satellite of the non-terrestrial network via an inter-satellite link (ISL). The satellite of the non-terrestrial network may be an NTN gNB-distributed unit (DU) of the non-terrestrial network. The ground station of the non-terrestrial network, together with the satellite of the non-terrestrial network, may perform base station functions of the non-terrestrial network. The split of base station functions between the ground station of the non-terrestrial network and the satellite of the non-terrestrial network may vary depending on an operator's system configuration. The base station of the non-terrestrial network may be referred to as a non-terrestrial base station or a satellite base station. The satellite of the non-terrestrial network may be connected to a terminal 450 through a service link or a user link. The service link or user link may be assumed to conform to the 3GPP NTN specifications.

The core network may be connected to a base station 440 of the terrestrial network via a backhaul. The base station of the terrestrial network may be connected to the terminal through a service link or a user link. The service link or user link may be assumed to conform to the 3GPP TN specifications. When the terminal receives services simultaneously from the terrestrial base station and the satellite base station, a problem may occur in one of the wireless connections. In such a case, the terminal may require a configuration procedure to continuously receive services.

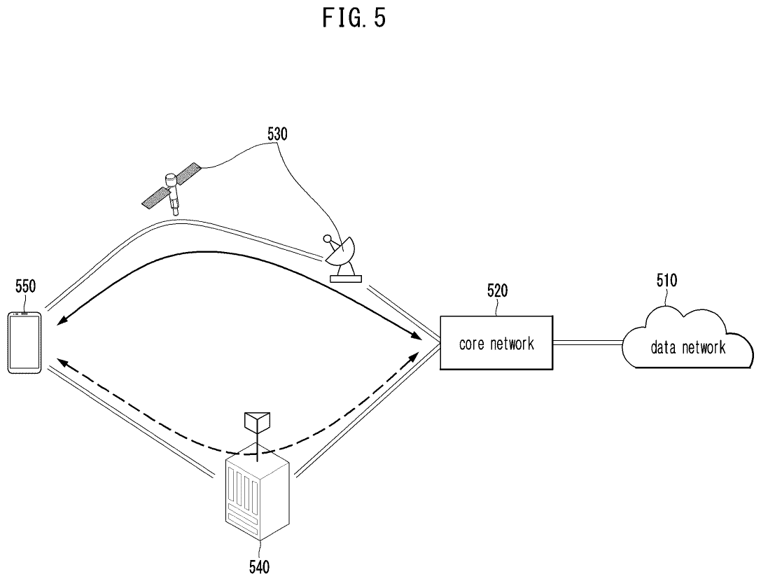

FIG. 5 is a conceptual diagram illustrating exemplary embodiments of an integrated network of a terrestrial network and a non-terrestrial network.

Referring to FIG. 5, an integrated network of a terrestrial network and a non-terrestrial network may include a data network 510, a core network 520, a satellite base station 530, a terrestrial base station 540, a terminal 550, and the like. In the integrated network, a terminal may be connected to the satellite base station and the terrestrial base station. The terminal may simultaneously receive services from the satellite base station and the terrestrial base station. The terminal may access one or more public land mobile networks (PLMNs). The terminal may establish one or more protocol data unit (PDU) sessions. The terminal may receive services from the terrestrial base station and the satellite base station through one or more established PDU sessions.

The terminal may receive services by being connected to both the terrestrial base station and the satellite base station through a single established PDU session. Alternatively, the terminal may receive services from the terrestrial base station and the satellite base station through respective PDU sessions for the terrestrial base station and the satellite base station. For example, the terminal may receive services through PDU sessions respectively from the terrestrial base station and the satellite base station.

The terminal connected to two base stations simultaneously (i.e. the terrestrial base station and the satellite base station) may require a specific procedure to continuously receive services according to a radio channel condition. The present disclosure proposes a specific procedure and method for providing service continuity to the terminal connected to two base stations simultaneously, which is different from the conventional handover procedure. For example, the present disclosure provides a network registration procedure and a PDU establishment procedure for the terminal to simultaneously receive services from the terrestrial base station and the satellite base station. The present disclosure proposes a configuration procedure and method required for the terminal, which is receiving services simultaneously from the terrestrial base station and the satellite base station, to receive services only from the terrestrial base station according to a specific event or a radio channel condition. The present disclosure proposes a configuration procedure and method required for the terminal, which is receiving services simultaneously from the terrestrial base station and the satellite base station, to receive services only from the satellite base station according to a specific event or a radio channel condition.

The 3GPP specifications define handover events and also define recovery procedures when there is a problem in a radio channel condition. A procedure required for a case when the terminal receiving services simultaneously from the terrestrial base station and the satellite base station needs to switch services to one side may be referred to as traffic steering or traffic switching.

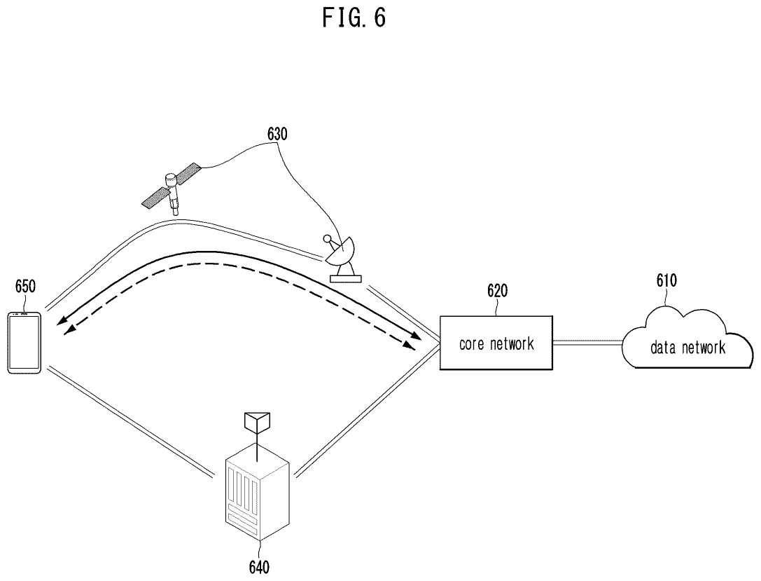

FIG. 6 is a conceptual diagram illustrating exemplary embodiments of a traffic steering method in an integrated network of a terrestrial network and a non-terrestrial network.

Referring to FIG. 6, an integrated network of a terrestrial network and a non-terrestrial network may include a data network 610, a core network 620, a satellite base station 630, a terrestrial base station 640, a terminal 650, and the like. In the integrated network, the terminal may perform a traffic steering procedure according to a radio channel condition while simultaneously receiving services by being connected to the satellite base station and the terrestrial base station. For example, the terminal may be connected only to the satellite base station to receive services.

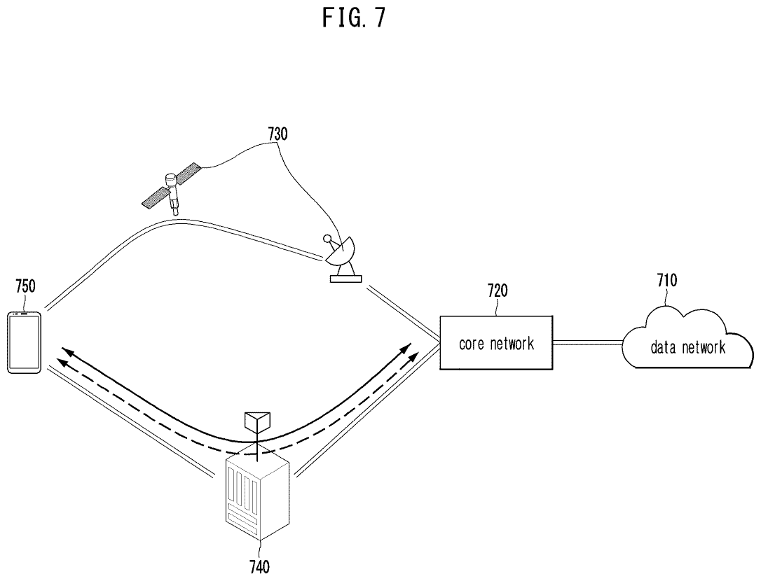

FIG. 7 is a conceptual diagram illustrating exemplary embodiments of a traffic steering method in an integrated network of a terrestrial network and a non-terrestrial network.

Referring to FIG. 7, an integrated network of a terrestrial network and a non-terrestrial network may include a data network 710, a core network 720, a satellite base station 730, a terrestrial base station 740, a terminal 750, and the like. In the integrated network, the terminal may perform a traffic steering procedure according to a radio channel condition while simultaneously receiving services by being connected to the satellite base station and the terrestrial base station. For example, the terminal may be connected only to the terrestrial base station to receive services.

The present disclosure proposes a network registration procedure for the terminal receiving services simultaneously from the terrestrial base station and the satellite base station as illustrated in FIG. 6.

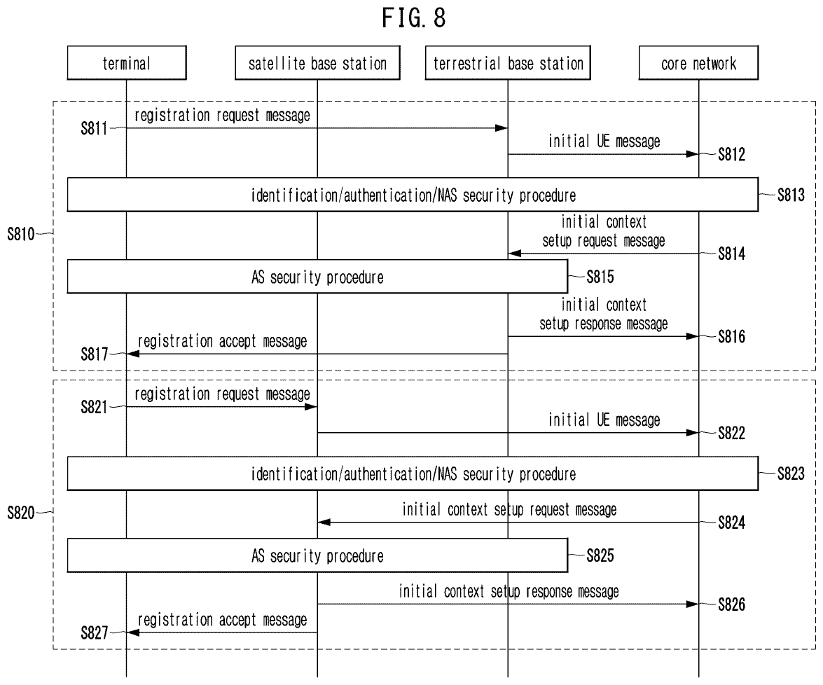

FIG. 8 is a sequence chart illustrating exemplary embodiments of a network registration method of a terminal.

Referring to FIG. 8, a terminal may be in a radio resource control (RRC) idle state with a terrestrial base station. The terminal may be in an RRC idle state also with a satellite base station. The terminal may perform a registration procedure via the terrestrial base station (S810). The terminal may transmit a registration request message requesting registration to the terrestrial base station (S811). The terrestrial base station may receive the registration request message requesting registration from the terminal. The registration request message may include registration type information and/or dual steering capability information indicating whether the terminal supports a dual steering function. The terrestrial base station may receive the registration request message from the terminal.

The terrestrial base station may transmit an initial UE message requesting registration of the terminal to a core network (e.g. access and mobility management function (AMF) entity) (S812). The initial UE message may include all or part of information included in the registration request message received from the terminal. For example, the initial UE message may include registration type information and/or dual steering capability information indicating that the terminal supports a dual steering function. The core network may receive the initial UE message requesting registration of the terminal from the terrestrial base station.

The terminal may proceed with a registration procedure via the satellite base station (S820). The terminal may transmit a registration request message requesting registration to the satellite base station (S821). The satellite base station may receive the registration request message requesting registration from the terminal. The registration request message may include registration type information and/or dual steering capability information indicating whether the terminal supports a dual steering function. The satellite base station may receive the registration request message from the terminal.

The satellite base station may transmit an initial UE message requesting registration of the terminal to the core network (e.g. AMF entity) (S822). The initial UE message may include all or part of information included in the registration request message received from the terminal. For example, the initial UE message may include registration type information and/or dual steering capability information indicating that the terminal supports a dual steering function. The core network may receive the initial UE message requesting registration of the terminal from the satellite base station.

The core network may identify that the terminal supports a dual steering function based on the received initial UE message. The core network may perform a registration procedure for the terminal based on the received initial UE message. The core network may perform an identification procedure, an authentication procedure, and a non-access stratum (NAS) security procedure via the terrestrial network or the non-terrestrial network based on the registration request in the received initial UE message (S813 or S823). The identification procedure may include a step in which the core network (e.g. AMF) transmits an identity request message to the terminal and a step in which the terminal transmits an identity response message to the core network. The authentication procedure may include a step in which the core network transmits an authentication request message to the terminal and a step in which the terminal transmits an authentication response message to the core network. The NAS security procedure may include a step in which the core network transmits a security mode command message to the terminal and a step in which the terminal transmits a security mode complete message to the core network.

The core network may determine, based on the received initial UE message, whether the terminal has a capability to connect to both the terrestrial network and the non-terrestrial network. The core network may determine that the terminal has the capability to connect to both the terrestrial network and the non-terrestrial network based on the dual steering capability information indicating that the terminal supports a dual steering function. The core network may transmit an initial context setup request message to the terrestrial base station (S814). The initial context setup request message may include a registration accept message. The terrestrial base station may receive the initial context setup request message from the core network.

The terrestrial base station may perform an access stratum (AS) security procedure with the terminal (S815). The terrestrial base station may perform an initial context setup procedure. The terrestrial base station may transmit an initial context setup response message to the core network (S816). The core network may receive the initial context setup response message from the terrestrial base station. The terrestrial base station may transmit a registration accept message to the terminal (S817). The terminal may receive the registration accept message from the terrestrial base station and may confirm the registration acceptance. The terminal may be in an RRC connected state with the terrestrial base station.

The core network may transmit an initial context setup request message to the satellite base station (S824). The initial context setup request message may include a registration accept message. The satellite base station may receive the initial context setup request message from the core network.

The satellite base station may perform an AS security procedure with the terminal (S825). The satellite base station may perform an initial context setup procedure. The satellite base station may transmit an initial context setup response message to the core network (S826). The core network may receive the initial context setup response message from the satellite base station. The satellite base station may transmit a registration accept message to the terminal (S827). The terminal may receive the registration accept message from the satellite base station and may confirm the registration acceptance. The terminal may be in an RRC connected state with the satellite base station.

The present disclosure proposes a procedure for registering PDU sessions by a terminal that simultaneously receives services from the terrestrial base station and the satellite base station, as illustrated in FIG. 6. The present disclosure proposes a procedure for simultaneously establishing PDU sessions for the satellite base station and the terrestrial base station. The terminal may transmit a PDU session establishment request message to the core network via the terrestrial base station. The core network may receive the PDU session establishment request message from the terminal via the terrestrial base station. Alternatively, the terminal may transmit a PDU session establishment request message to the core network via the satellite base station. The core network may receive the PDU session establishment request message via the satellite base station. The core network may proceed with a PDU session establishment procedure with the satellite base station and the terrestrial base station.

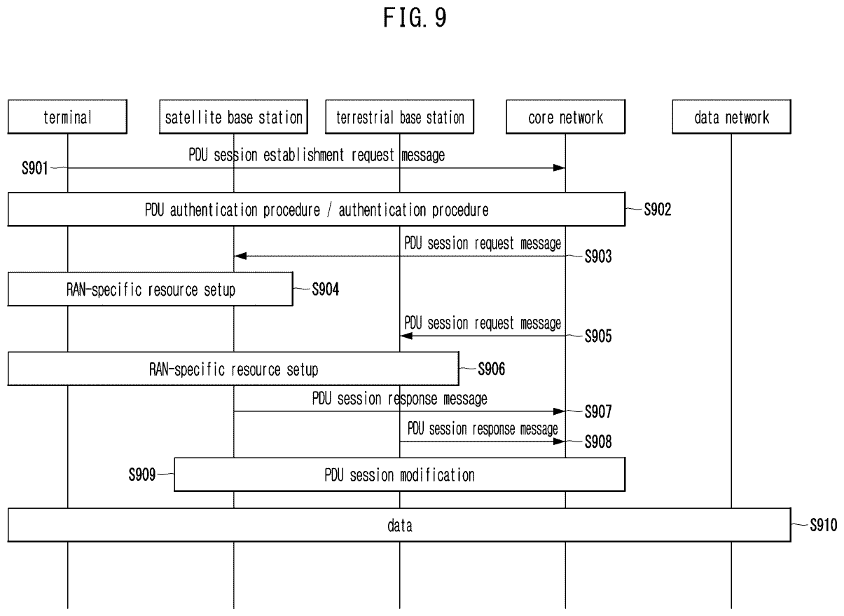

FIG. 9 is a sequence chart illustrating exemplary embodiments of a PDU session establishment method.

Referring to FIG. 9, a terminal may be in an RRC connected state with a satellite base station. The terminal may be in an RRC connected state with a terrestrial base station. The terminal may transmit a PDU session establishment request message to a core network (e.g. AMF entity) via the terrestrial base station or the satellite base station (S901). In other words, the terminal may transmit the PDU session establishment request message to the core network (e.g. AMF entity) via the terrestrial base station. The core network (e.g. AMF entity) may receive the PDU session establishment request message from the terminal via the terrestrial base station. Alternatively, the terminal may transmit a PDU session establishment request message to the core network (e.g. AMF entity) via the satellite base station. The core network (e.g. AMF entity) may receive the PDU session establishment request message from the terminal via the satellite base station. The PDU session establishment request message may include a PDU session identifier (ID), request type, and dual steering capability information indicating that the terminal supports a dual steering function.

The core network (e.g. AMF entity) may perform a PDU session authentication procedure or an authentication procedure for the terminal based on the PDU session establishment request message received from the terminal (S902). The core network (e.g. AMF entity) may identify that the terminal supports a dual steering function based on the received PDU session establishment request message. The core network (e.g. AMF entity) may perform a PDU session establishment procedure for the terminal based on the received PDU session establishment request message.

The core network (e.g. AMF entity) may transmit a PDU session request message to the satellite base station (S903). The PDU session request message may include the PDU session ID and request type included in the PDU session establishment request message. The satellite base station may receive the PDU session request message from the core network. The satellite base station may perform a radio access network (RAN)-specific resource setup procedure for the terminal to configure RAN-specific resources (S904). In the RAN-specific resource setup procedure for the terminal, a GPRS tunnel protocol (GTP) tunnel may be established between the satellite base station and the core network, and a radio bearer may be established between the terminal and the satellite base station. In the RAN-specific resource setup procedure for the terminal, a session may be established between the terminal and the satellite base station. The satellite base station may transmit a PDU session response message to the core network (S907). The core network may receive the PDU session response message from the satellite base station.

The core network may transmit a PDU session request message to the terrestrial base station (S905). The PDU session request message may include the PDU session ID and request type included in the PDU session establishment request message. The terrestrial base station may receive the PDU session request message from the core network. The terrestrial base station may perform a RAN specific-resource setup procedure for the terminal to configure RAN-specific resources (S906). In the RAN-specific resource setup procedure for the terminal, a GTP tunnel may be established between the terrestrial base station and the core network, and a radio bearer may be established between the terminal and the terrestrial base station. In the RAN-specific resource setup procedure for the terminal, a session may be established between the terminal and the terrestrial base station. The terrestrial base station may transmit a PDU session response message to the core network (S908). The core network may receive the PDU session response message from the terrestrial base station.

The core network, the satellite base station, and the terrestrial base station may proceed with a PDU session modification procedure (S909). The terminal may transmit data to a data network via the satellite base station using the established PDU session. The data network may receive the data from the terminal via the satellite base station. The terminal may transmit data to the data network via the terrestrial base station using the established PDU session (S910). The data network may receive the data from the terminal via the terrestrial base station using the established PDU session.

The terminal may be in a state of being connected to both the satellite base station and the terrestrial base station. The terminal may transmit a radio status report to the core network. The core network may receive the radio status report from the terminal. The core network may determine traffic switching based on the received radio status report. A radio connection status between the terrestrial base station and the terminal may be poor. A procedure for traffic switching in such a case is described.

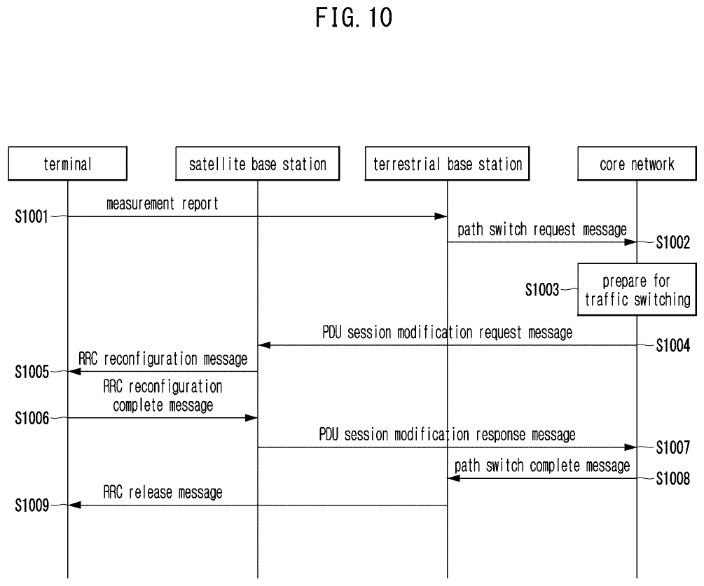

FIG. 10 is a sequence chart illustrating exemplary embodiments of a traffic switching method in a terrestrial network and a non-terrestrial network.

Referring to FIG. 10, a terminal may be in an RRC connected state with a terrestrial base station. The terminal may receive services from the terrestrial base station while in the RRC connected state with the terrestrial base station. The terrestrial base station and a satellite base station may preconfigure an event condition for traffic switching to the terminal. For example, the event condition for traffic switching may include a case when a received signal strength of the terrestrial base station falls below a specific value. When the event condition is satisfied, the terminal may transmit a measurement report including the received signal strength of the terrestrial base station to the terrestrial base station (S1001). The terrestrial base station may receive the measurement report from the terminal and identify the received signal strength of the terrestrial base station. The received signal strength of the terrestrial base station may be radio status information.

The event condition for traffic switching may be defined as a traffic switching rule. In the case of a terminal capable of being connected to both the terrestrial base station and the satellite base station, the terrestrial base station may configure the traffic switching rule for the terminal. The satellite base station may configure the traffic switching rule for the terminal. The terminal may determine whether a condition for transmitting a measurement report is satisfied based on the configured traffic switching rule.

The terrestrial base station may transmit a path switch request message including the radio status information to the core network (S1002). The core network may receive the path switch request message including the radio status information from the terrestrial base station. The core network may prepare for traffic switching to switch a data path between the terrestrial base station and the terminal to a data path between the satellite base station and the terminal based on the received radio status information (S1003). The core network may configure a connected path for the terminal according to the traffic switching rule.

The core network may transmit a PDU session modification request message to the satellite base station in order to modify a PDU session, originally established with the terrestrial base station, so that it is established with the satellite base station (S1004). The satellite base station may receive the PDU session modification message from the core network. The satellite base station may transmit an RRC reconfiguration message to the terminal to additionally establish a data radio bearer between the satellite base station and the terminal (S1005). The terminal may receive the RRC reconfiguration message from the satellite base station.

The terminal may reconfigure the RRC connection based on the received RRC reconfiguration message to additionally establish a data radio bearer between the satellite base station and the terminal. After completing establishment of the radio bearer, the terminal may transmit an RRC reconfiguration complete message to the satellite base station (S1006). The satellite base station may receive the RRC reconfiguration complete message from the terminal. The satellite base station may transmit a path switch modification response message to the core network (S1007). The core network may receive the path switch modification response message from the satellite base station. The core network may transmit a path switch complete message to the terrestrial base station (S1008). The terrestrial base station may receive the path switch complete message from the core network. The terrestrial base station may transmit an RRC release message to the terminal (S1009). The terminal may receive the RRC release message from the terrestrial base station and may release the RRC configuration. The terrestrial base station may transmit an RRC suspend message to the terminal. The terminal may receive the RRC suspend message from the terrestrial base station and may suspend the RRC configuration and transition to an RRC inactive state with the terrestrial base station.

Meanwhile, the terminal may be in a state of being connected to both the satellite base station and the terrestrial base station. The terminal may transmit a radio status report to the core network. The core network may receive the radio status report from the terminal. The core network may determine traffic switching based on the received radio status report. The connection status between the satellite base station and the terminal may be poor. A procedure for traffic switching in such a case is described.

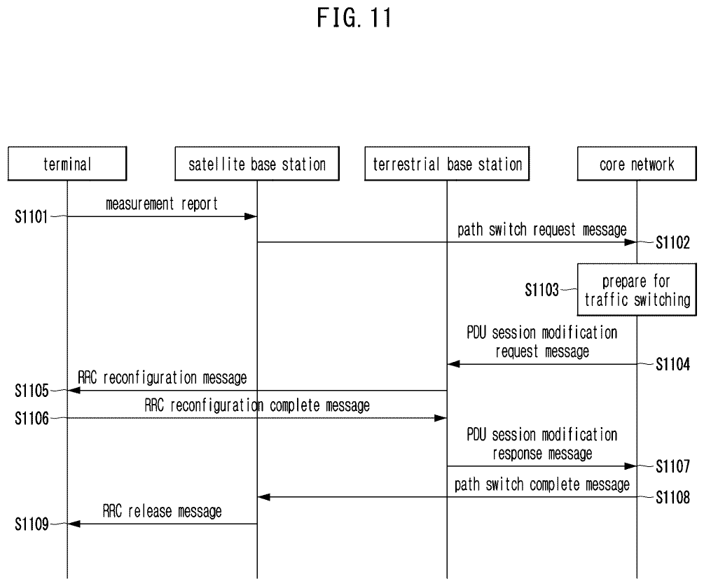

FIG. 11 is a sequence chart illustrating exemplary embodiments of a traffic switching method in a terrestrial network and a non-terrestrial network.

Referring to FIG. 11, a terminal may be in an RRC connected state with a satellite base station. The terminal may receive services from the satellite base station while in the RRC connected state with the satellite base station. The satellite base station and a terrestrial base station may preconfigure an event condition for traffic switching to the terminal. For example, the event condition for traffic switching may include a case when a received signal strength of the satellite base station falls below a specific value. When the event condition is satisfied, the terminal may transmit a measurement report including the received signal strength of the satellite base station to the satellite base station (S1101). The satellite base station may receive the measurement report from the terminal and identify the received signal strength of the satellite base station. The received signal strength of the satellite base station may be radio status information.

The event condition for traffic switching may be defined as a traffic switching rule. In the case of a terminal capable of being connected to both the terrestrial base station and the satellite base station, the terrestrial base station may configure the traffic switching rule for the terminal. The satellite base station may configure the traffic switching rule for the terminal. The terminal may determine whether a condition for transmitting a measurement report is satisfied based on the configured traffic switching rule.

The satellite base station may transmit a path switch request message including the radio status information to the core network (S1102). The core network may receive the path switch request message including the radio status information from the satellite base station. The core network may prepare for traffic switching to switch a data path between the satellite base station and the terminal to a data path between the terrestrial base station and the terminal based on the received radio status information (S1103). The core network may configure a connected path of the terminal according to the traffic switching rule.

The core network may transmit a PDU session modification request message to the terrestrial base station in order to modify a PDU session, originally established with the satellite base station, so that it is established with the terrestrial base station (S1104). The terrestrial base station may receive the PDU session modification message from the core network. The terrestrial base station may transmit an RRC reconfiguration message to the terminal to additionally establish a data radio bearer between the terrestrial base station and the terminal (S1105). The terminal may receive the RRC reconfiguration message from the terrestrial base station.

The terminal may reconfigure the RRC connection based on the received RRC reconfiguration message to additionally establish a data radio bearer between the terrestrial base station and the terminal. After completing establishment of the radio bearer, the terminal may transmit an RRC reconfiguration complete message to the terrestrial base station (S1106). The terrestrial base station may receive the RRC reconfiguration complete message from the terminal. The terrestrial base station may transmit a path switch modification response message to the core network (S1107). The core network may receive the path switch modification response message from the terrestrial base station. The core network may transmit a path switch complete message to the satellite base station (S1108). The satellite base station may receive the path switch complete message from the core network. The satellite base station may transmit an RRC release message to the terminal (S1109). The terminal may receive the RRC release message from the satellite base station and may release the RRC configuration. The terrestrial base station may transmit an RRC suspend message to the terminal. The terminal may receive the RRC suspend message from the terrestrial base station and may suspend the RRC configuration and transition to an RRC inactive state with the terrestrial base station. The terminal may transition to an RRC inactive state with the satellite base station.

The present disclosure proposes a procedure in which a terminal capable of being connected to both a satellite base station and a terrestrial base station reestablishes a connection when one of the wireless connections is lost. For example, the present disclosure proposes a procedure in which the terminal in an RRC inactive state with the terrestrial base station resumes the terrestrial connection to enable dual steering. A connection resumption procedure for the satellite base station may be similar to the connection resumption procedure for the terrestrial base station. The present disclosure proposes a procedure in which, during a radio connection resumption procedure for a dual-steering capable terminal, the terminal deletes a DRB in a previously connected RAN. The present disclosure proposes a procedure in which, during a radio connection resumption procedure for a dual-steering capable terminal, the terminal resumes the radio connection while maintaining the connection with the previously connected RAN.

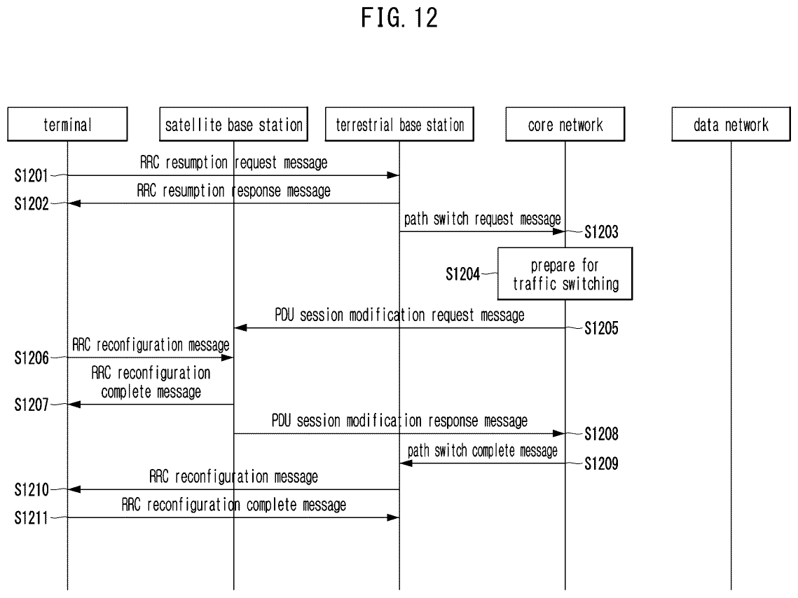

FIG. 12 is a sequence chart illustrating exemplary embodiments of a connection resumption method in a terrestrial network and a non-terrestrial network.

Referring to FIG. 12, a terminal may be in an RRC connected state with a satellite base station. The terminal may be in an RRC inactive state with a terrestrial base station. The terminal may receive services from the satellite base station while in the RRC connected state with the satellite base station. The terrestrial base station may preconfigure a service request condition for the terminal. The terminal in the RRC inactive state with the terrestrial base station may search for a suitable terrestrial base station and may transmit an RRC resume request message to the suitable terrestrial base station (S1201). The RRC resume request message may be a service request message.

During the process of searching for a terrestrial base station, the terminal may determine whether to connect to a terrestrial base station in consideration of battery consumption or channel condition. The terrestrial base station may receive the RRC resume request message from the terminal. The terrestrial base station may transmit an RRC resume response message to the terminal (S1202). The terminal may receive the RRC resume response message from the terrestrial base station.

The terrestrial base station may transmit a path switch request message to the core network (S1203). The core network may receive the path switch request message from the terrestrial base station. The core network may prepare for traffic switching to switch a data path between the satellite base station and the terminal to a data path between the terrestrial base station and the terminal (S1204). The core network may configure a connected path of the terminal according to the traffic steering rule.

The core network may transmit a PDU session modification request message to the satellite base station in order to modify a PDU session, originally established with the terrestrial base station, so that it is established with the satellite base station (S1205). The satellite base station may receive the PDU session modification request message from the core network. The satellite base station may transmit an RRC reconfiguration message to the terminal to delete a data radio bearer between the satellite base station and the terminal (S1206). The terminal may receive the RRC reconfiguration message from the satellite base station.

The terminal may reconfigure the RRC connection based on the received RRC reconfiguration message to delete the data radio bearer between the satellite base station and the terminal. After completing deletion of the radio bearer, the terminal may transmit an RRC reconfiguration complete message to the satellite base station (S1207). The satellite base station may receive the RRC reconfiguration complete message from the terminal. The satellite base station may transmit a PDU session modification response message to the core network (S1208). The core network may receive the PDU session modification response message from the satellite base station. The core network may transmit a path switch complete message to the terrestrial base station (S1209). The terrestrial base station may receive the path switch complete message from the core network. The terrestrial base station may transmit an RRC reconfiguration message to the terminal to additionally establish a data radio bearer between the terrestrial base station and the terminal (S1210). The terminal may receive the RRC reconfiguration message from the terrestrial base station.

The terminal may reconfigure the RRC connection based on the received RRC reconfiguration message to additionally establish a data radio bearer between the terrestrial base station and the terminal. After completing establishment of the radio bearer, the terminal may transmit an RRC reconfiguration complete message to the terrestrial base station (S1211). The terrestrial base station may receive the RRC reconfiguration complete message from the terminal. The terminal may transition to an RRC connected state with the terrestrial base station.

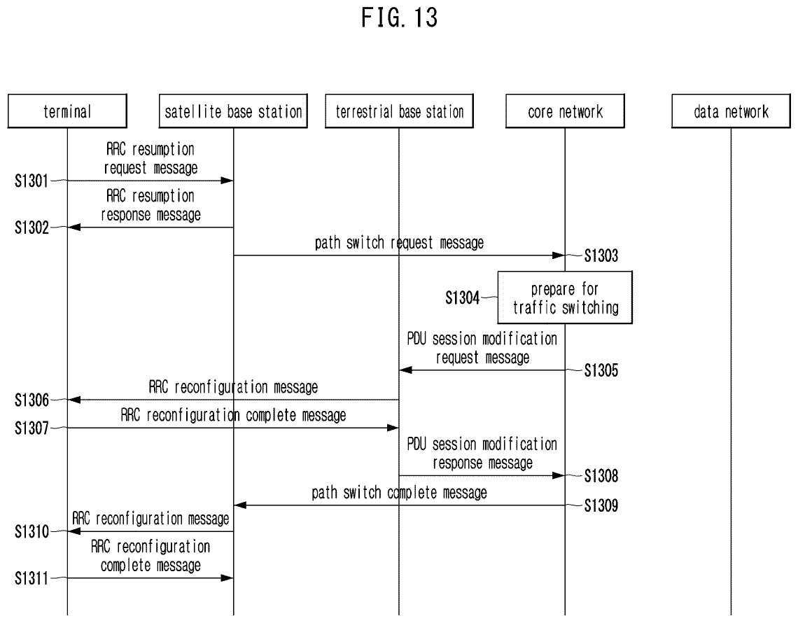

FIG. 13 is a sequence chart illustrating exemplary embodiments of a connection resumption method in a terrestrial network and a non-terrestrial network.

Referring to FIG. 13, a terminal may be in an RRC connected state with a terrestrial base station. The terminal may be in an RRC inactive state with a satellite base station. The terminal may receive services from the terrestrial base station while in the RRC connected state with the terrestrial base station. The satellite base station may preconfigure a service request condition to the terminal. The terminal in the RRC inactive state with the satellite base station may search for a suitable satellite base station and may transmit an RRC resume request message to the suitable satellite base station (S1301). The RRC resume request message may be a service request message.

During the process of searching for a satellite base station, the terminal may determine whether to connect to a satellite base station in consideration of battery consumption or channel condition. The satellite base station may receive the RRC resume request message from the terminal. The satellite base station may transmit an RRC resume response message to the terminal (S1302). The terminal may receive the RRC resume response message from the satellite base station.

The satellite base station may transmit a path switch request message to the core network (S1303). The core network may receive the path switch request message from the satellite base station. The core network may prepare for traffic switching to switch a data path between the terrestrial base station and the terminal to a data path between the satellite base station and the terminal (S1304). The core network may configure a connected path of the terminal according to the traffic steering rule.

The core network may transmit a PDU session modification request message to the terrestrial base station in order to modify a PDU session, originally established with the terrestrial base station, so that it is established with the satellite base station (S1305). The terrestrial base station may receive the PDU session modification request message from the core network. The terrestrial base station may transmit an RRC reconfiguration message to the terminal to delete a data radio bearer between the terrestrial base station and the terminal (S1306). The terminal may receive the RRC reconfiguration message from the terrestrial base station.

The terminal may reconfigure the RRC configuration based on the received RRC reconfiguration message to delete the data radio bearer between the terrestrial base station and the terminal. After completing deletion of the radio bearer, the terminal may transmit an RRC reconfiguration complete message to the terrestrial base station (S1307). The terrestrial base station may receive the RRC reconfiguration complete message from the terminal. The terrestrial base station may transmit a PDU session modification response message to the core network (S1308). The core network may receive the PDU session modification response message from the terrestrial base station. The core network may transmit a path switch complete message to the satellite base station (S1309). The satellite base station may receive the path switch complete message from the core network. The satellite base station may transmit an RRC reconfiguration message to the terminal to additionally establish a data radio bearer between the satellite base station and the terminal (S1310). The terminal may receive the RRC reconfiguration message from the satellite base station.

The terminal may reconfigure the RRC connection based on the received RRC reconfiguration message to additionally establish the data radio bearer between the satellite base station and the terminal. After completing establishment of the radio bearer, the terminal may transmit an RRC reconfiguration complete message to the satellite base station (S1311). The satellite base station may receive the RRC reconfiguration complete message from the terminal.

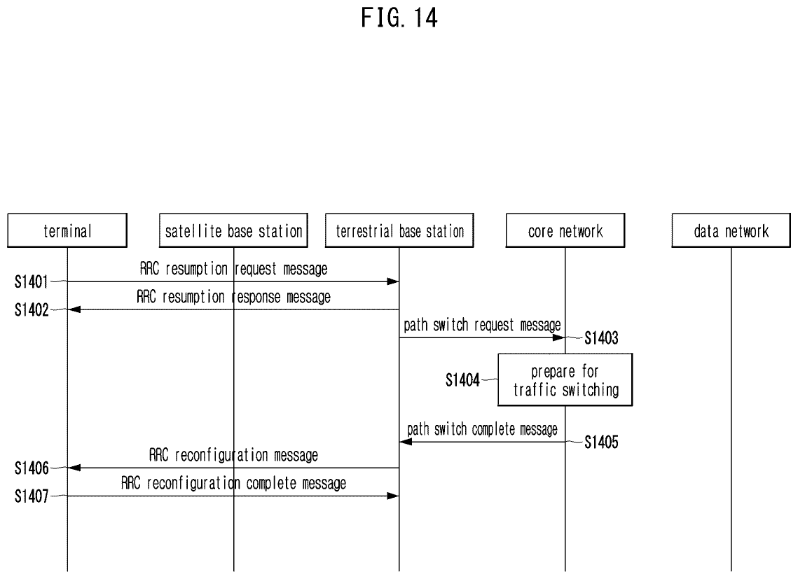

FIG. 14 is a sequence chart illustrating exemplary embodiments of a connection resumption method in a terrestrial network and a non-terrestrial network.

Referring to FIG. 14, a terminal may be in an RRC connected state with a satellite base station. The terminal may be in an RRC inactive state with a terrestrial base station. The terminal may receive services from the satellite base station while in the RRC connected state with the satellite base station. The terrestrial base station may preconfigure a service request condition to the terminal. The terminal in the RRC inactive state with the terrestrial base station may search for a suitable terrestrial base station and may transmit an RRC resume request message to the suitable terrestrial base station (S1401). The RRC resume request message may be a service request message.

During the process of searching for a terrestrial base station, the terminal may determine whether to connect to a terrestrial base station in consideration of battery consumption or channel condition. The terrestrial base station may receive the RRC resume request message from the terminal. The terrestrial base station may transmit an RRC resume response message to the terminal (S1402). The terminal may receive the RRC resume response message from the terrestrial base station.

The terrestrial base station may transmit a path switch request message to the core network (S1403). The core network may receive the path switch request message from the terrestrial base station. The core network may prepare for traffic switching to switch a data path between the satellite base station and the terminal to a data path between the terrestrial base station and the terminal (S1404). The core network may configure a connected path of the terminal according to the traffic steering rule.

The core network may transmit a path switch complete message to the terrestrial base station (S1405). The terrestrial base station may receive the path switch complete message from the core network. The terrestrial base station may transmit an RRC reconfiguration message to the terminal to additionally establish a data radio bearer between the terrestrial base station and the terminal (S1406). The terminal may receive the RRC reconfiguration message from the terrestrial base station.

The terminal may reconfigure the RRC connection based on the received RRC reconfiguration message to additionally establish the data radio bearer between the terrestrial base station and the terminal. After completing establishment of the radio bearer, the terminal may transmit an RRC reconfiguration complete message to the terrestrial base station (S1407). The terrestrial base station may receive the RRC reconfiguration complete message from the terminal.

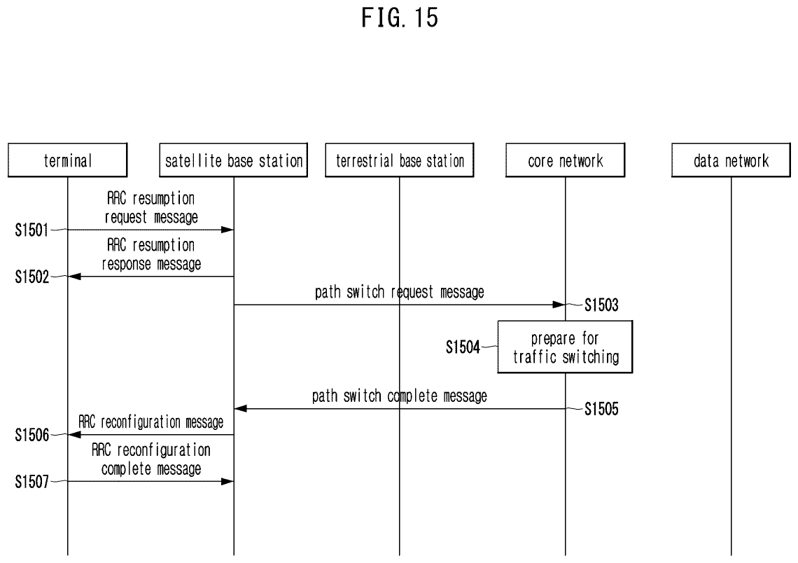

FIG. 15 is a sequence chart illustrating exemplary embodiments of a connection resumption method in a terrestrial network and a non-terrestrial network.

Referring to FIG. 15, a terminal may be in an RRC connected state with a terrestrial base station. The terminal may be in an RRC inactive state with a satellite base station. The terminal may receive services from the terrestrial base station while in the RRC connected state with the terrestrial base station. The satellite base station may preconfigure a service request condition to the terminal. The terminal in the RRC inactive state with the satellite base station may search for a suitable satellite base station and may transmit an RRC resume request message to the suitable satellite base station (S1501). The RRC resume request message may be a service request message.

During the process of searching for a satellite base station, the terminal may determine whether to connect to a satellite base station in consideration of battery consumption or channel condition. The satellite base station may receive the RRC resume request message from the terminal. The satellite base station may transmit an RRC resume response message to the terminal (S1502). The terminal may receive the RRC resume response message from the satellite base station.

The satellite base station may transmit a path switch request message to the core network (S1503). The core network may receive the path switch request message from the satellite base station. The core network may prepare for traffic switching to switch a data path between the terrestrial base station and the terminal to a data path between the satellite base station and the terminal (S1504). The core network may configure a connected path of the terminal according to the traffic steering rule.

The core network may transmit a path switch complete message to the satellite base station (S1505). The satellite base station may receive the path switch complete message from the core network. The satellite base station may transmit an RRC reconfiguration message to the terminal to additionally establish a data radio bearer between the satellite base station and the terminal (S1506). The terminal may receive the RRC reconfiguration message from the satellite base station.

The terminal may reconfigure the RRC connection based on the received RRC reconfiguration message to additionally establish the data radio bearer between the satellite base station and the terminal. After completing establishment of the radio bearer, the terminal may transmit an RRC reconfiguration complete message to the satellite base station (S1507). The satellite base station may receive the RRC reconfiguration complete message from the terminal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
establishing radio resource control (RRC) connected states with a first base station and a second base station;
transmitting, to a mobility management function entity and via the first base station, a protocol data unit (PDU) session establishment request message including dual steering capability information indicating support of a dual steering function of the terminal;
performing a first radio access network (RAN)-specific resource setup procedure according to a first PDU session request of the mobility management function entity;
establishing a first session with the first base station according to the first RAN-specific resource setup procedure;
performing a second RAN-specific resource setup procedure according to a second PDU session request of the mobility management function entity; and
establishing a second session with the second base station according to the second RAN-specific resource setup procedure.

2. The method according to claim 1, wherein the establishing of the RRC connected states comprises:
transmitting, to the mobility management function entity and via the first base station, a registration request message including the dual steering capability information while in a first RRC idle state with the first base station;
transmitting, to the mobility management function entity and via the second base station, the registration request message while in a second RRC idle state with the first base station;
performing an identification procedure, an authentication procedure, and a non-access stratum (NAS) security procedure with the mobility management function entity;
receiving a first registration accept message from the first base station and transitioning to the RRC connected state; and
receiving a second registration accept message from the second base station and transitioning to the RRC connected state.

3. The method according to claim 1, further comprising:
in response to an event condition for traffic switching being satisfied, transmitting radio status information of the first base station to the first base station;
receiving, from the second base station, a first RRC reconfiguration message for additional establishment of a first data radio bearer;
additionally establishing the first data radio bearer with the second base station; and
transitioning to an RRC inactive state with the first base station.

4. The method according to claim 3, further comprising:
transmitting an RRC resume request message to the first base station;
receiving an RRC resume response message from the first base station;
receiving, from the second base station, a second RRC reconfiguration message for deleting the first data radio bearer;
deleting the first data radio bearer with the second base station; and
establishing a connection with the first base station and transitioning to the RRC connected state.

5. The method according to claim 4, wherein the establishing of the connection with the first base station and the transitioning to the RRC active state comprises:
receiving, from the first base station, a third RRC reconfiguration message for additional establishment of a second data radio bearer;
additionally establishing the second data radio bearer with the first base station; and
establishing a connection with the first base station and transitioning to the RRC connected state.

6. The method according to claim 3, further comprising:
transmitting an RRC resume request message to the first base station;
receiving an RRC resume response message from the first base station;
receiving, from the first base station, a fourth RRC reconfiguration message for additional establishment of a third data radio bearer;
additionally establishing the third data radio bearer with the first base station; and
establishing a connection with the first base station and transitioning to the RRC connected state.

7. A method of a first base station, comprising:
establishing a radio resource control (RRC) connected state with a terminal;
receiving, from the terminal, a protocol data unit (PDU) session establishment request message including dual steering capability information indicating support of a dual steering function of the terminal;
transmitting the PDU session establishment request message including the dual steering capability information to a mobility management function entity;
receiving a PDU session request message from the mobility management function entity;
performing a radio access network (RAN)-specific resource setup procedure with the terminal according to the PDU session request message; and
establishing a session with the terminal according to the RAN-specific resource setup procedure.

8. The method according to claim 7, wherein the establishing of the RRC connected state with the terminal comprises:
receiving, from the terminal, a registration request message including the dual steering capability information in an RRC idle state with the terminal;
transmitting the registration request message to the mobility management function entity;
relaying an identification procedure, an authentication procedure, and a non-access stratum (NAS) security procedure between the mobility management function entity and the terminal;
receiving an initial context setup request message from the mobility management function entity;
transmitting a registration accept message to the terminal; and
establishing the RRC connected state.

9. The method according to claim 7, further comprising:
receiving, from the terminal, radio status information of the terminal and the first base station;
transmitting a first path switch request message to the mobility management function entity;
receiving a first path switch complete message from the mobility management function entity; and
releasing a connection with the terminal.

10. The method according to claim 9, further comprising:
receiving an RRC resumption request message from the terminal;
transmitting a second path switch request message for RRC resumption to the mobility management function entity;
receiving a second path switch complete message from the mobility management function entity; and
resuming a connection with the terminal.

11. The method according to claim 10, wherein the resuming of the connection with the terminal comprises:
transmitting, to the terminal, a first RRC reconfiguration message for additional establishment of a first data radio bearer;
additionally establishing the first data radio bearer with the terminal; and
receiving a first RRC reconfiguration complete message from the terminal and resuming the connection.

12. The method according to claim 9, further comprising:
receiving a first PDU session modification request message from the mobility management function entity;
transmitting, to the terminal, a second RRC reconfiguration message for deleting a second data radio bearer;
deleting the second data radio bearer with the terminal;
receiving a second RRC reconfiguration complete message from the terminal; and
transmitting a first PDU session modification response message to the mobility management function entity.

13. The method according to claim 7, further comprising:
receiving a second PDU session modification request message from mobility management function entity;
transmitting, to the terminal, a third RRC reconfiguration message for additional establishment of a third data radio bearer;
additionally establishing the third data radio bearer with the terminal;
receiving a third RRC reconfiguration complete message from the terminal; and
transmitting a second PDU session modification response message to the mobility management function entity.

14. A terminal comprising at least one processor, wherein the at least one processor causes the terminal to perform:
establishing radio resource control (RRC) connected states with a first base station and a second base station;
transmitting, to a mobility management function entity and via the first base station, a protocol data unit (PDU) session establishment request message including dual steering capability information indicating support of a dual steering function of the terminal;
performing a first radio access network (RAN)-specific resource setup procedure according to a first PDU session request of the mobility management function entity;
establishing a first session with the first base station according to the first RAN-specific resource setup procedure;
performing a second RAN-specific resource setup procedure according to a second PDU session request of the mobility management function entity; and
establishing a second session with the second base station according to the second RAN-specific resource setup procedure.

15. The terminal according to claim 14, wherein the at least one processor further causes the terminal to perform:
in response to an event condition for traffic switching being satisfied, transmitting radio status information of the first base station to the first base station;
receiving, from the second base station, a first RRC reconfiguration message for additional establishment of a first data radio bearer;
additionally establishing the first data radio bearer with the second base station; and
transitioning to an RRC inactive state with the first base station.

16. The terminal according to claim 15, wherein the at least one processor further causes the terminal to perform:
transmitting an RRC resume request message to the first base station;
receiving an RRC resume response message from the first base station;
receiving, from the second base station, a second RRC reconfiguration message for deleting the first data radio bearer;
deleting the first data radio bearer with the second base station; and
establishing a connection with the first base station and transitioning to the RRC connected state.

17. The terminal according to claim 16, wherein in the establishing of the connection with the first base station and the transitioning to the RRC active state, the at least one processor further causes the terminal to perform:
receiving, from the first base station, a third RRC reconfiguration message for additional establishment of a second data radio bearer;
additionally establishing the second data radio bearer with the first base station; and
establishing a connection with the first base station and transitioning to the RRC connected state.

18. The terminal according to claim 15, wherein the at least one processor further causes the terminal to perform:
transmitting an RRC resume request message to the first base station;
receiving an RRC resume response message from the first base station;
receiving, from the first base station, a fourth RRC reconfiguration message for additional establishment of a third data radio bearer,
additionally establishing the third data radio bearer with the first base station; and
establishing a connection with the first base station and transitioning to the RRC connected state.
